(19) United States
(12) Patent Application Publication
(10) Pub. No.: US 2024/0003488 A1
(43) Pub. Date: Jan. 4, 2024

(54) LIQUID APPLICATOR

(71) Applicant: RI INVESTMENTS (PTY) LTD, Cape Town (ZA)

(72) Inventors: Alan HODSON, Cape Town (ZA); Denis FUTTER, Cape Town (ZA)

(73) Assignee: RI INVESTMENTS (PTY) LTD, Cape Town (ZA)

(21) Appl. No.: 18/039,445

(22) PCT Filed: Nov. 30, 2021
(86) PCT No.: PCT/IB2021/061116

§ 371 Date: May 30, 2023

(30) Foreign Application Priority Data
Nov. 30, 2020 (ZA) 2020/07428

(51) Int. Cl. F16N 3/06

(52) U.S. Cl. CPC F16N 3/06; F16N 2210/33

(57) ABSTRACT

This invention relates to a liquid applicator 10 that comprises a resilient deformable container 12 for holding a liquid 14 and an applicator head 16 for abutting an elongated article. The applicator head 16 defines a first connecting formation 20 that is connectable to a first connecting portion 22 on the container 12 in order to connect the container 12 and applicator head 16 to each other. The applicator head 16 further defines an inlet 24 which is in fluid flow communication with and receives liquid 14 from the container 12 when the container 12 is connected to the applicator head 16.

### FIELD OF THE INVENTION

This invention relates to a liquid applicator. More particularly, but not exclusively, this invention relates to a liquid applicator that facilitates controlled application of a liquid onto an article. The invention also extends to a method of applying a liquid onto an article.

### BACKGROUND TO THE INVENTION

Surfaces of articles that come into contact with each other as a result of relative motion of the bodies experience friction and wear. One example of such an article is a chain. Chains are well known and widely used for transmitting mechanical power on many kinds of domestic, industrial and agricultural machinery, including conveyors, motorcycles, bicycles, and the like. Conventionally, they consist of a series of spaced apart short cylindrical rollers held together by side links, and are driven by a toothed wheel, called a sprocket.

In many instances, chains have to operate in dirty conditions and necessarily will experience relatively high rates of friction and wear. In order to reduce the same and increase their performance, chains are known to be lubricated from time to time. This could be done in several ways. A method which is widely utilised in the cycling environment involves squeezing lubricant from a container, having an elongate rigid nozzle, onto the chain links. A drawback associated with this method is that it is difficult for a person to control the amount of lubricant ejecting from the nozzle when applying pressure on the container. This often causes the lubricant to be applied unevenly, with either too much or too little lubricant being deposited onto parts of the chain. As a result, lubricant often drips from over lubricated regions of the chain, and under lubricated regions of the chain are prone to higher friction and wear rates.

### OBJECT OF THE INVENTION

It is accordingly an object of the present invention to provide a liquid applicator which seeks to, at least partially, overcome the abovementioned drawback, and/or which provides a useful alternative to existing liquid applicators.

### SUMMARY OF THE INVENTION

According to a first aspect of the invention, there is provided a liquid applicator suitable for applying a liquid onto an article, the liquid applicator comprising an applicator head including:
a first connecting formation that is connectable to a container for holding the liquid;
an inlet for receiving liquid from the container when the container is connected to the first connecting formation;
an abutting portion for abutting the article; and
a valve body protruding from the abutting portion, the valve body defining an outlet and an internal passage extending, at least partially, between the inlet and outlet for conveying liquid operatively entering the inlet from the container to the outlet, the valve body is resiliently deformable operatively to permit the passage to at least partially collapse and cause liquid in the passage to be urged through the outlet and onto the article, when the valve body comes into contact with the article.

There is provided for the valve body to be movable between a protruding position wherein the valve body protrudes from the abutting portion when the valve body is spaced from the article, and a collapsed position wherein the valve body is deformed towards the abutting portion and the passage is at least partially collapsed when the valve body is in contact with the article. The volume of the passage is less when the valve body is in its collapsed position compared to its protruding position, causing at least some liquid present therein to discharge from the passage through the outlet when valve body moves to its collapsed position from its protruding position.

The abutting portion and valve body are configured such that during movement of the article relative to the applicator head along a path extending adjacent to the abutting portion, the abutting portion remains in contact with the article and the valve body moves between its protruding and collapsed positions depending on the shape of the article. Preferably, the abutting portion may extend beyond a periphery of the valve body, when viewed along the passage.

The valve body may comprise a spout. More specifically, the spout may comprise a hollow cylindrical body that defines at one end thereof the outlet, and the passage extending through its interior, with the hollow cylindrical body orientated such to extend away from the abutting portion.

The spout may be between 1 mm and 7 mm in length. Preferably, the spout may be at least 2 mm in length. More preferably, the spout may be at least 3 mm in length.

The valve body may be of a polymeric material, more preferably, of a rubber-like material, and most preferably, of silicone.

The valve body may define a cut-out or notch, adjacent the outlet, to assist in the discharge of liquid through the outlet.

Preferably, the valve body may be adapted to permit the passage to at least partially collapse in response to the article making sideways contact with the valve body, taken with respect to a direction the valve body protrudes from the abutting portion.

There is provided for the abutting portion to be stiffer than the valve body. The abutting portion may be in the form of a substantially flat surface, with the valve body protruding therefrom.

According to an example embodiment of the invention, the applicator head may include spaced apart opposing first and second guides respectively located adjacent opposing sides of the abutting portion, the first and second guides define between them a cavity for receiving the article and the first and second guides further guide the article's position on the abutting portion when it is brought into abutment with the abutting portion. Preferably, the first and second guides may be configured to operatively engage opposing sides of the article when it abuts the abutting portion.

The abutting portion and first and second guides may collectively form a u-shaped figure when viewed from the side.

The first and second guides may respectively include first and second wiper means facing each other and wiping operatively the opposing sides of the article during movement of the article through the cavity.

The first and second wiper means may be elastic whereby they are able to remain in contact with the sides of the article during said movement of the article through the cavity, even though the width of the article could vary at various positions along its length.

There is provided for each of the first and second wiper means to comprise a plurality of wiper elements or fins. According to an example embodiment, the wiper elements of each of the first and second wiper means may be spaced apart axially along a path the article operatively moves through the cavity. There is provided for the wiper elements to be elongated wiper elements, to extend substantially parallel to one another, and arranged so to extend substantially perpendicular to the path.

The first and second guides may respectively include first and second rigid wiper supports. The first and second rigid wiper supports may respectively hold the first and second wiper means in a preferred orientation with respect to each other.

The container may include a first connecting portion that is complementary shaped to the first connecting formation, wherein mating of the first connecting formation with the first connecting portion connects the applicator head and container to each other. Preferably, the first connecting formation and first connecting portion may each be a screw thread.

There is also provided for the container to be resiliently deformable operatively, wherein in response to pressure being applied onto the container, the liquid inside the container is pressurised that causes it to escape from the container through the inlet, and subsequently, through the outlet.

There is further provided for the liquid applicator to include a sealing member which is adapted to seat in and seal the outlet. The sealing member may be shaped and sized to form an interference fit with the outlet to seal tightly against it. The sealing member may remove unwanted matter from the outlet and/or passage when seated in the outlet.

In one example embodiment of the invention, the liquid applicator includes a protective cover that includes the sealing member and a second connecting portion, and the applicator head includes a second connecting formation that is complementary shaped to the second connecting portion, wherein mating of the second connecting formation with the second connecting portion connects the applicator head and protective cover to each other. Preferably, the second connecting formation and second connecting portion may each be a screw thread.

The article may comprise an elongated article. The article may include any one selected from the group comprising a chain, gear, toothed belt, cable, bearing, and an article having an elongated uneven or castellated surface.

Preferably, the liquid comprises a lubricant.

According to a second aspect of the invention, there is provided a method of applying a liquid onto an article, including the steps of:
abutting the article with a liquid applicator;
moving the liquid applicator and the article relative to each other along a longitudinal direction of the article whilst the liquid applicator remains in abutment with the article; and
causing an amount of liquid to be urged out of the liquid applicator and onto the article when part of the liquid applicator is deformed against the article.

There is provided for the amount of liquid to be equal to an internal volume of the part that is deformed against the article.

The liquid applicator may engage opposing sides of the article during said movement of the applicator relative to the article.

The method may include the step of, during said relative movement of the liquid applicator and the article, causing the part of the liquid applicator to move between a protruding position wherein the part is in an undeformed state when it is spaced from the article, and a collapsed position wherein the part is in a deformed state when it is in contact with the article, wherein the amount of liquid is urged out of the liquid applicator when the part moves to its collapsed position.

Pressure may be applied to the liquid applicator during said movement of the liquid applicator relative to the article.

These and other features of the invention are described in more detail below.

### BRIEF DESCRIPTION OF THE ACCOMPANYING DRAWINGS

One embodiment of the invention is described below, by way of a non-limiting example only and with reference to the accompanying drawings in which:

FIG. 1 shows a partial exploded perspective view from above of a liquid applicator, in accordance with the invention;

FIG. 2 is a partial exploded perspective view from below of the liquid applicator of FIG. 1;

FIG. 3 is a partial sectioned view of the liquid applicator of FIG. 1;

FIG. 4 is a detailed view of a corresponding portion of the liquid applicator shown in FIG. 3;

FIG. 5 represents is similar view to that illustrated in FIG. 3, with the liquid applicator in an assembled configuration;

FIG. 6 is a detailed view of a corresponding portion of the liquid applicator shown in FIG. 5;

FIGS. 7a-c show an uppermost portion of the liquid applicator and part of a chain, in section, with the liquid applicator in an inverted position and operatively applying liquid onto the chain; and

FIG. 8 illustrates a rear view of the liquid applicator and chain as seen in FIGS. 7a-c.

### DETAILED DESCRIPTION OF AN EXAMPLE EMBODIMENT OF THE INVENTION

With reference to the drawings, in which like numerals refer to like features, a liquid applicator according to an example embodiment of the invention is generally designated by reference numeral 10.

The applicator 10 comprises a resilient deformable container 12 for holding a liquid, in the current example embodiment being in the form of a lubricant 14, and an applicator head 16 for abutting an elongated article, in the current example embodiment being in the form of a chain 18, during movement A of the chain 18 relative to the applicator head 16 along a path B extending adjacent to the applicator head 16.

The applicator head 16 defines a first connecting formation 20 that is connectable to a first connecting portion 22 on the container 12 in order to connect the container 12 and applicator head 16 to each other.

The applicator head 16 further defines an inlet 24 which is in fluid flow communication with and receives liquid 14 from the container 12 when the container 12 is connected to the applicator head 16.

The applicator head 16 further defines an abutting portion 26 for abutting the article 18, and a valve body 28 that protrudes from the abutting portion 26. The valve body 28 defines an outlet 30 and an internal passage 32 that extends, at least partially, between the inlet 24 and outlet 30 to convey operatively, to the outlet 30, lubricant 14 that operatively enters the inlet 24 from the container 12. The valve body 28 is resiliently deformable operatively so that, in response to it coming into contact with the chain 18 during said relative movement A between the chain 18 and applicator head 16, the passage 32 at least partially collapses which causes at least some lubricant 14 present in the passage 32 to be urged out through the outlet 30 and be deposited on the chain 18.

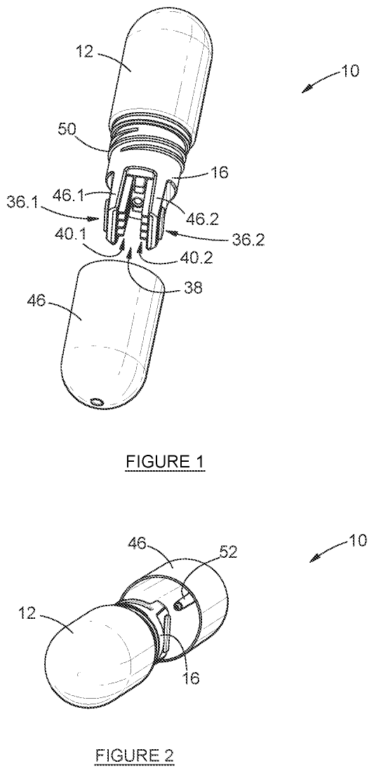

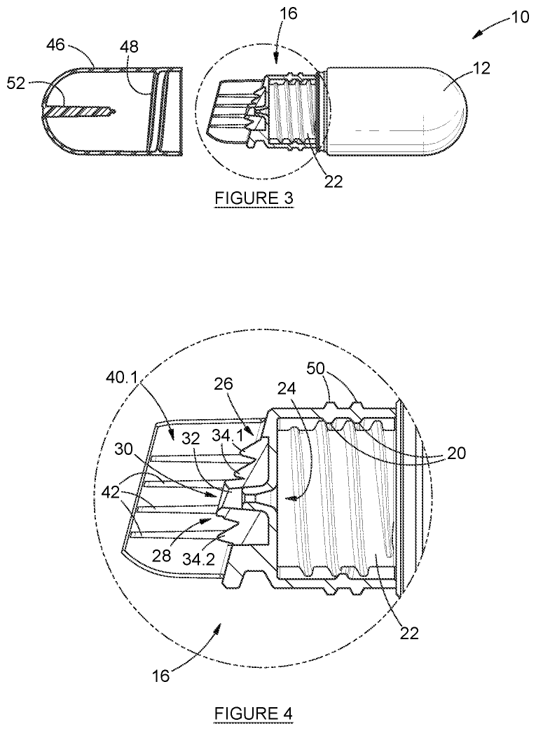

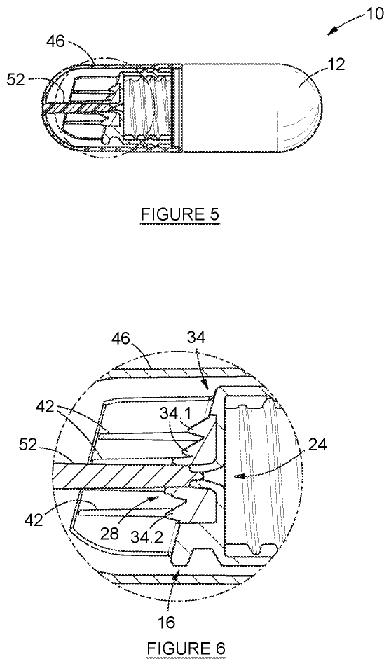

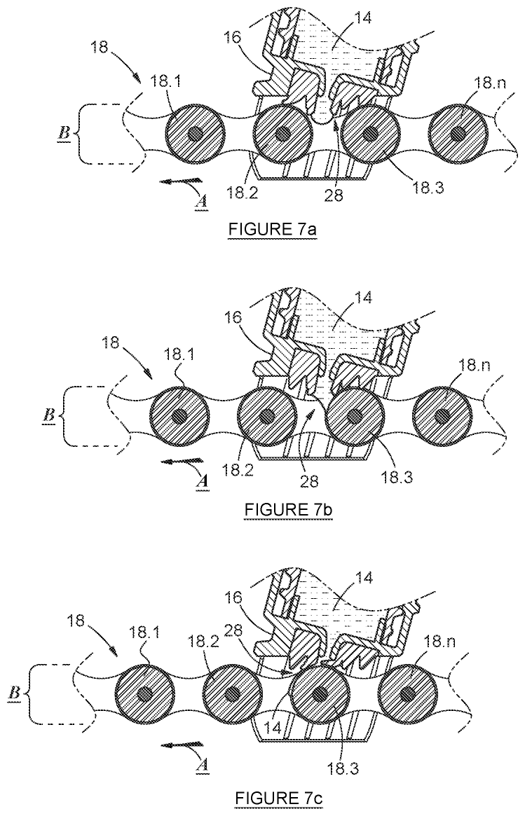

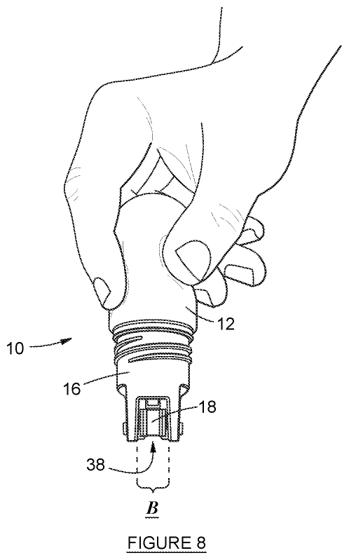

The valve body 28 is movable between a protruding position (shown in FIGS. 1-7b) wherein the valve body 28 protrudes from the abutting portion 26 when the valve body 28 is spaced from the chain 18, and a collapsed position (shown in FIGS. 7c and 8) wherein the valve body 28 is deformed towards the abutting portion 26 and the passage 32 is at least partially collapsed when the valve body 28 is in contact with the chain 18. As can be best seen at the hand of FIG. 7a-7c, the volume of the passage 32 is less when the valve body 28 is in its collapsed position compared to when it is in its protruding position, thereby causing at least some liquid 14 present therein to discharge from the passage 32 through the outlet 30 when the valve body 28 moves to its collapsed position from its protruding position.

The abutting portion 26 and valve body 28 are configured such that during relative movement A between the article 18 and applicator head 16, along the path B extending adjacent to the abutting portion 26, the abutting portion 26 remains in contact with the article 18 and the valve body 28 moves between its protruding and collapsed positions depending on the shape of the article 18. It would be appreciated that the valve body 28 moves about when moving between its protruding position and collapsed position. The abutting portion 26 is wider than the valve body 28 and extends beyond a periphery of the valve body 28, when viewed along the passage 32.

The valve body 28 comprises an elongated body that is in the form of a spout. More specifically, the spout 28 comprises a hollow cylindrical body that defines at one end thereof the outlet 30, and the passage 32 extending through its interior, with the hollow cylindrical body orientated such to extend away from the abutting portion 26.

The spout is between 1 mm and 7 mm in length. According to an example embodiment, the spout is at least 2 mm in length.

The valve body 28 defines a cut-out or notch (not shown), adjacent the outlet 30, to assist in the discharge of liquid 14 through the outlet 30.

The valve body 28 extends into the path B such to operatively come into contact with rollers 18.1-18.n of the chain 18 when the applicator head 16 abuts a top face of the chain 18, and the applicator head 16 and chain 18 move relative to each other. As is best illustrated in FIGS. 1 and 4, the valve body 28 is cylindrically-shaped, has an o-shaped profile in end view, and defines an o-shaped outlet 30. In order for it to be resiliently deformable, the valve body 28 is manufactured from a polymeric material such as silicone. One of the ends of the valve body 28 is secured to applicator head 16 and hence it will be appreciated that when a lateral force is exerted onto the valve body 28, such as when it makes contact with the rollers 18.1-18.n during said relative movement A, it will deform to such an extent that the passage 32 collapses which, in turn, causes the volume of the passage 32 to reduce and lubricant 14 therein to discharge through the outlet 30.

The abutting portion 26 further includes two ridges 34.1 protruding therefrom adjacent upstream of the valve body 28 (i.e., the direction from which the chain 18 is intended to move A when operatively passing by the head 16 along the path B), and one ridge 34.2 protruding therefrom adjacent downstream of the valve body 28 (i.e., the direction towards which the chain 18 is intended to move A when operatively passing by the head 16 along the path B). The ridges 34.1 and 34.2 protrude into and are slanted with respect to the path B in the downstream direction.

At least part of the abutting portion 26 is stiffer than the valve body 28. Preferably, the at least part of the abutting portion 26 is rigid.

The applicator head 16 further includes spaced apart opposing first and second guides 36.1, 36.2 respectively located adjacent opposing sides of the abutting portion 26. The first and second guides 36.1, 36.2 are orientated such to extend substantially perpendicular to the abutting portion 26. The first and second guides 36.1, 36.2 define between them a cavity 38 for receiving the article 18 and the first and second guides 36.1, 36.2 further guide the article's position on the abutting portion 26 when it is brought into abutment with the abutting portion 26. The first and second guides 36.1, 36.2 are configured to operatively engage opposing sides of the article 18 when it abuts the abutting portion 26. The abutting portion 26 and first and second guides 36.1, 36.2 collectively form a u-shaped figure when viewed from the side, with the abutting portion 26 forming the lower part thereof and the guides 36.1 and 36.2 the respective sides of the figure. The path B extends through the cavity 38.

The first and second guides 36.1, 36.2 respectively include first and second wiper means 40.1 and 30.2 which are configured operatively to engage opposing sides of the chain 18 to dislodge dirt (not shown) from it during said relative movement A between the chain 18 and applicator 10 along the path B. In order to achieve such cleaning effect, the wiper means 40.1 and 40.2 are arranged on the applicator head 16 whereby they protrude above the applicator head 16 adjacent either side of the valve body 28, and are spaced apart and positioned on opposing sides of the path B. More specifically, the wiper means 40.1 and 40.2 are spaced apart laterally with respect to the longitudinal direction of the path B, and by a distance that is smaller than the width of the path B such that they, at least partially, protrude into the path B. This enables them to remain in contact with the chain 18 whilst it is moving A through the cavity 38, even though the width of the chain 18 could vary at various positions along its length.

The first and second wiper means 40.1 and 40.2 are similar, with each of them including a plurality of wiper elements or fins 42, as best shown in FIGS. 1, 4 and 6. Each wiper element 42 comprises a thin blade-like element that is attached at an outer side to a remainder of the support 36.1 or 36.2, with an opposing inner free side protruding into the path B. The wiper elements 42 of each of the first and second wiper means 40.1 and 40.2 are arranged such that they are spaced apart axially along the length of the path B. According to the example embodiment illustrated, the wiper elements 42 are elongate elements which are arranged to extend from a remainder of the applicator head 16 substantially perpendicular to the path B.

Like with the valve body 28, the first and second wiper means 40.1 and 40.2, and hence the wiper elements 42, are manufactured from a suitable material that would render them resiliently deformable, including a polymeric material, such as silicone.

The first and second guides 36.1, 36.2 further respectively includes first and second rigid wiper supports 44.1, 44.2, which respectively hold the first and second wiper means 40.1, 40.2 in a preferred orientation with respect to each other, and hence the article 18 in a preferred orientation with respect to the abutting portion 26 when received thereon.

In an example embodiment of the invention, the valve body 28, ridges 34.1, 34.2, and wiper means 40.1, 40.2 are of unitary construction, wherein a remainder of the applicator head 16 is of unitary construction. More specifically, the valve body 28, ridges 34.1, 34.2, and wiper means 40.1, 40.2 are resiliently deformable, and the remainder of the applicator head is rigid.

The container 12 is removably connectable to the applicator head 16 by mating the first connecting formation 20 with the first connecting portion 22, which are complementary shaped. The first connecting formation 20 and first connecting portion 22 each comprise a screw thread. When the head 16 is removed from the container 12, the container 12 is open and can be filled with lubricant 14.

The container 12 is resiliently deformable operatively, wherein in response to pressure being applied onto the container 12, the liquid 14 inside the container 12 is pressurised that causes it to escape from the container 12 through the inlet 24, and subsequently, through the outlet 30.

The applicator 10 further includes a protective cover 46 that is removably attachable to the head 16 and hence the container 12 by means of a threaded engagement. The protective cover 46 includes a second connecting portion 48, and the applicator head 16 includes a second connecting formation 50 that is complementary shaped to the second connecting portion 48, wherein mating of the second connecting formation 50 with the second connecting portion 48 connects the applicator head 16 and protective cover 46 to each other. The second connecting formation 50 and second connecting portion 48 each comprise a screw thread.

A sealing member, in the form of a pin 52, protrudes from an inside of the cover 50, with the cover 50 being configured such that a free end of the pin 52 seats in the outlet 30 with the cover 50 secured on the applicator head 16. More specifically, the free end of the pin 52 is complementary-shaped to the outlet 30 wherein it sealingly engages and forms an interference fit with the outlet 30 when seated therein and prevents any lubricant 14 from passing through the outlet 30 and hence leaking from the container 12. Furthermore, the sealing member 52 removes unwanted matter from the outlet 30 and/or passage 32 when seated in the outlet 30. The sealing effect is enhanced by virtue of the fact that the valve body 28, on which the outlet 30 is defined, is of resiliently deformable material. In the example embodiment, the pin 52, applicator head 16 and container 12 extend co-axially.

In use, the applicator head 16 is, in an inverted position, placed over the article 18 and brought into abutment with the article 18 that is located in the cavity 38, and the applicator head 16 engaging opposing sides of the article 18, as shown in FIGS. 7a and 8. Pressure is applied to the container 12 whilst the applicator head 16 and the article 18 are moved A relative to each other along the path B that extends along a longitudinal direction of the article 18. When the part of the applicator head 16, being in the form of the valve body 28, comes into contact with the article 18, as shown in FIG. 7b, and is subsequently deformed against the article 18 after further relative movement A, as shown in FIG. 7c, an amount of liquid 14 is urged out of the valve body 28, through the outlet 30, and deposited onto the article 18. The amount of liquid 14 deposited is a droplet and corresponds substantially to the volume of the internal passage 32.

During said relative movement A of the applicator head 16 and the article 18, the valve body 28 moves between a protruding position wherein it in an undeformed state when it is spaced from the article 18 (shown in FIG. 7a), and a collapsed position wherein the valve body 28 is in a deformed state when it is in contact with the article 18, wherein the amount of liquid 14 is urged out of the valve body 28 when the valve body 28 moves to its collapsed position (shown in FIG. 7c).

It will be appreciated that as a result of the applicator's 10 unique configuration, it will be able to apply the desired amount of liquid 14 (corresponding to approximately the volume of the passage 32) onto each roller 18.1 to 18.n upon the valve body 28 coming into contact and deforming against the same, whilst the wiper means 40.1 and 40.2 simultaneously scrapes excess dirt off the chain 18.

It will be appreciated by those skilled in the art that the invention is not limited to the precise details as described herein and that many variations are possible without departing from the scope and spirit of the invention. Whilst the article 18 in the foregoing example has been in the form of the chain, it will be appreciated that it may also comprise a gear, toothed belt, cable, bearing or any article having an elongated uneven or castellated surface. Furthermore, the applicator head 16 may include a plurality of valve bodies 28, preferably located adjacent each other. This would be especially useful where it is desirous to deposit liquid onto parallel surface, in a single relative movement, such as the case is with heavy duty or double chains.

The foregoing example has been provided merely for the purposes of explanation and is in no way to be construed as limiting of the present invention. While the present invention has been described with reference to an exemplary embodiment only, it is understood that the words which have been used herein are words of description and illustration, rather than words of limitation. The present invention is also not intended to be limited to the particulars disclosed herein. Rather, the present invention extends to all functionally equivalent structures, methods and uses, such as are within the scope of the invention.

1. A liquid applicator suitable for applying a liquid onto an article, the liquid applicator comprising an applicator head including:
a first connecting formation that is connectable to a container for holding the liquid;
an inlet for receiving liquid from the container when the container is connected to the first connecting formation;
an abutting portion for abutting the article; and
a valve body protruding from the abutting portion, the valve body defining an outlet and a passage extending, at least partially, between the inlet and outlet for conveying liquid operatively entering the inlet from the container to the outlet, the valve body is resiliently deformable operatively to permit the passage to at least partially collapse and cause liquid in the passage to be urged through the outlet and onto the article, when the valve body comes into contact with the article, and the valve body is further movable between a protruding position wherein the valve body protrudes from the abutting portion when the valve body is spaced from the article, and a collapsed position wherein the valve body is deformed towards the abutting portion and the passage is at least partially collapsed when the valve body is in contact with the article.

2. (canceled)

3. The liquid applicator as claimed in claim 1, wherein the abutting portion and valve body are configured such that during movement of the article relative to the applicator head along a path extending adjacent to the abutting portion, the abutting portion remains in contact with the article and the valve body moves between its protruding and collapsed positions depending on the shape of the article.

4. The liquid applicator as claimed in claim 1, wherein the valve body includes a hollow cylindrical body that defines at one end thereof the outlet, and the passage extending through its interior, the cylindrical body being at least 2 mm in length.

5. The liquid applicator as claimed in claim 1, wherein the abutting portion is stiffer than the valve body and extends beyond a periphery of the valve body when viewed along the passage.

6. The liquid applicator as claimed in claim 1, wherein the applicator head includes spaced apart opposing first and second guides respectively located adjacent opposing sides of the abutting portion, the first and second guides define between them a cavity for receiving the article and guide the article's position on the abutting portion when brought into abutment with the abutting portion.

7. The liquid applicator as claimed in claim 6, wherein the first and second guides are configured to operatively engage opposing sides of the article when the article abuts the abutting portion.

8. The liquid applicator as claimed in claim 7, wherein the first and second guides respectively include first and second wipers facing each other for wiping the opposing sides of the article during movement of the article through the cavity.

9. The liquid applicator as claimed in claim 8, wherein the first and second wipers are elastic and are able to remain in contact with the opposing sides of the article during said movement of the article through the cavity, even though the width of the article could vary at various positions along its length.

10. The liquid applicator as claimed in claim 8, wherein the first and second guides respectively includes first and second rigid wiper supports for respectively holding the first and second wipers in a preferred orientation with respect to each other.

11. The liquid applicator as claimed in claim 1, including the container, wherein the container includes a first connecting portion that is complementary shaped to the first connecting formation, further wherein mating of the first connecting formation and the first connecting portion with each other connects the applicator head and container to each other.

12. The liquid applicator as claimed in claim 1, including a sealing member which is adapted to seat in and seal the outlet, the sealing member is shaped and sized such to form an interference fit with the outlet to tightly seal against it.

13. The liquid applicator as claimed in claim 12, including a protective cover that includes the sealing member and a second connecting portion, and the applicator head includes a second connecting formation that is complementary shaped to the second connecting portion, wherein mating of the second connecting formation and the second connecting portion with each other connects the applicator head and protective cover to each other.

14. A method of applying a liquid onto an article, including the steps of:
abutting the article with a liquid applicator;
moving the liquid applicator and the article relative to each other along a longitudinal direction of the article whilst the liquid applicator remains in abutment with the article; and
causing an amount of liquid to be urged out of the liquid applicator and onto the article when a part of the liquid applicator is deformed against the article,
wherein the amount of liquid is equal to an internal volume of the part of the liquid applicator that is deformed against the article.

15. (canceled)

16. The method as claimed in claim 14, wherein the liquid applicator engages opposing sides of the article during said movement of the liquid applicator relative to the article.

17. The method as claimed in claim 14, including, during said relative movement of the liquid applicator and the article, causing the part of the liquid applicator to move between a protruding position wherein the part of the liquid applicator is in an undeformed state when spaced from the article, and a collapsed position wherein the part of the liquid applicator is in a deformed state when in contact with the article, wherein the amount of liquid is urged out of the liquid applicator when the part of the liquid applicator moves to its collapsed position.

18. The method as claimed in claim 14, including, applying pressure to the liquid applicator during said movement of the liquid applicator relative to the article.
